(19) United States
(12) Patent Application Publication
(10) Pub. No.: US 2022/0318716 A1
(43) Pub. Date: Oct. 6, 2022

(54) PERFORMANCE SUMMARIZATION OVER TIME

(71) Applicant: BetterWorks Systems, Inc., Redwood City, CA (US)

(72) Inventors: Michael John Serrano Dandan, Millbrae, CA (US); Shawn Venkat, Foster City, CA (US); Ravindranath Yanamandra, Union City, CA (US)

(21) Appl. No.: 17/222,639

(22) Filed: Apr. 5, 2021

(51) Int. Cl. G06Q 10/06; G06F 40/30; G06N 20/00

(52) U.S. Cl. CPC G06Q 10/06398; G06F 40/30; G06N 20/00; G06Q 10/06393

(57) ABSTRACT

Techniques are described that provide users with performance summarizations over time. In some cases, an enterprise system receives a first performance evaluation for an employee at a first time, and receives a second performance evaluation for the employee at a second time. The enterprise system determines semantic meanings for text strings included in the first and second performance evaluations. The enterprise system inputs the semantic meanings into a machine-learned model trained to determine performance over time based at least in part on semantics of employee feedback. The enterprise system receives a performance score for the employee from the machine-learned model that reflects how the semantic meanings have changed over time. The enterprise system displays the performance score in a user interface, and may also display other performance scores for the employee, a rank of the employee based on the performance score, and/or other performance metrics.

### BACKGROUND

Performance evaluations are a common technique to provide feedback to employees on their performance. Different metrics associated with employee performance, along with performance evaluations themselves, are increasingly being documented using computer systems. However, conventional systems that document performance of an employee for an evaluation have limitations on how information about an employee is presented, which can cause frustration for both an employer and the employee.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a schematic view of an example system usable to implement example techniques for performance summarization over time as described herein.

FIG. 2 depicts an example user interface that is usable to provide a performance summarization over time using the techniques described herein.

FIG. 3 illustrates a flowchart outlining an example method to utilize a machine-learned model to determine a performance score based on semantic meanings derived from performance evaluations received at different times using the techniques described herein.

FIG. 4 illustrates a flowchart outlining an example method to modify a performance score for an employee based on status of completion of a goal associated with the employee using the techniques described herein.

FIG. 5 illustrates a flowchart outlining an example method to rank employees based on performance scores using the techniques described herein.

FIG. 6 is an example system and device that is usable to implement the techniques described herein.

### DETAILED DESCRIPTION

As discussed above, documentation of employee performance and performance evaluations using conventional computing systems have limitations, such as when users want a comprehensive assessment of an employee over time. For example, conventional systems for documenting employee performance and displaying performance metrics often only display metrics associated with a most recent quarter-year (also referred to herein as a “quarter”). Some conventional systems allow users to navigate to performance metrics associated with previous quarters. However, these conventional systems simply provide a single snapshot of a set time period, and fail to provide an assessment of how an employee's performance has changed over time (e.g., over multiple quarters, multiple years, etc.).

Additionally, conventional systems require quantitative metrics to be input into the systems for display as part of a performance evaluation for an employee. These conventional systems not only have no mechanism for analyzing quantitative feedback provided about an employee, but also fail to track how quantitative feedback may change over time. Accordingly, these conventional systems are frustrating for both employers and employees to evaluate how the employee's performance has (or has not) changed over time.

This application describes techniques for providing performance summarization over time via an enterprise system and/or service (herein referred to as an “enterprise system”). Various examples of the present disclosure include systems, methods, and non-transitory computer-readable media of an enterprise system.

For instance, in one example, an enterprise system may operate a service that corresponds to a dedicated application installed on a user device. The enterprise system may be associated with an organization (e.g., an employer) having one or more users (e.g., employees, independent contractors, volunteers, etc.). The enterprise system may enable users to share content via the application installed on the user device. In some cases, the shared content may be accessed (e.g., viewed) by devices associated with other users that also have the application installed on their respective devices. Alternatively or additionally, the enterprise system may enable users to share content, and/or access (e.g., view) content shared by other user accounts, via a web-based application accessed via a web browser. The enterprise system may store account information associated with each user and the respective device on which the application is installed and/or via which the enterprise system is accessed.

In some examples, the enterprise system receives performance evaluations associated with an employee at different times. For example, the enterprise system may receive a performance evaluation each month, each quarter, biannually (e.g., each half-year), each year, etc. while an employee is employed by a company. The performance evaluation may include quantitative metrics related to a number of projects completed, timeliness on projects, efficiency on projects, sales revenue, number of sales completed, and the like. Additionally, in some cases, the performance evaluation may include qualitative analysis provided by users of the enterprise system, such as one or more supervisors of the employee, one or more subordinates of the employee, one or more colleagues of the employee, one or more customers that interacted with the employee, one or more contractors that interacted with the employee, and so forth. In some examples, the qualitative analysis may include text inputs (e.g., a text string) provided by users of the enterprise system. For instance, the enterprise system may solicit open-ended feedback from users of the enterprise system regarding a particular employee for a performance evaluation, allowing the users to provide responses “in their own words.”

In examples, the performance evaluations that include open-ended, qualitative feedback in the form of text strings are analyzed by the enterprise system to determine how the feedback changes over time. For instance, the enterprise system may determine semantic meanings of the text strings included in the performance evaluations using a language processing neural network. The enterprise system may then input the semantic meanings associated with the different performance evaluations into a machine-learned model trained to determine performance over time based at least in part on semantics of employee feedback. The machine-learned model may include one or more supervised models (e.g., classification, regression, similarity, or other type of model), unsupervised models (e.g., clustering, neural network, or other type of model), and/or semi-supervised models configured to determine performance over time based at least in part on semantics of employee feedback, for example.

In some examples, the enterprise system receives a performance score for the employee from the machine-learned model, where the performance score represents the semantic meanings received with the performance evaluations at different times. The enterprise system may then display the performance score, and analysis, metrics, and the like associated with the performance score, in a user interface for review by users of the enterprise system. For instance, the performance score may illustrate a trend or trajectory for the employee over time, which is based on open-ended feedback received from users of the enterprise system. The open-ended feedback may capture sentiments of users who interact with the employee that may not otherwise be captured by qualitative metrics or closed-ended questions alone. Additionally, by representing sentiments over time, the enterprise system can consolidate large amounts of data (e.g., dozens, hundreds, etc. of performance evaluations with open-ended questions) into a single metric which is easier for users of the enterprise system, including the employee, to understand.

In this way, the enterprise system improves functioning of a computing device by reducing an amount of processing resources used by the enterprise system and by reducing an amount of data sent over a network. For example, conventional systems required users to select individual performance periods (e.g., quarters, years, etc.), then select individual performance evaluations to evaluate open-ended responses included in the performance reviews. Accordingly, significant processing resources were consumed in conventional systems to navigate through, access, and display multiple performance evaluations, with large amounts of data sent over a network between the enterprise system and various computing devices during such analysis of an employee. In contrast, the described techniques provide a comprehensive performance score that takes open-ended responses included in multiple different performance evaluations into consideration over time, thus reducing processing resources by the enterprise system and data sent over a network between the enterprise system and computing devices associated with users of the enterprise system.

These and other aspects are described further below with reference to the accompanying drawings. The drawings are merely example implementations and should not be construed to limit the scope of the claims. For example, while examples are illustrated in the context of a user interface for a mobile device, the techniques may be implemented using any computing device and the user interface may be adapted to the size, shape, and configuration of the particular computing device.

### Example System Architecture

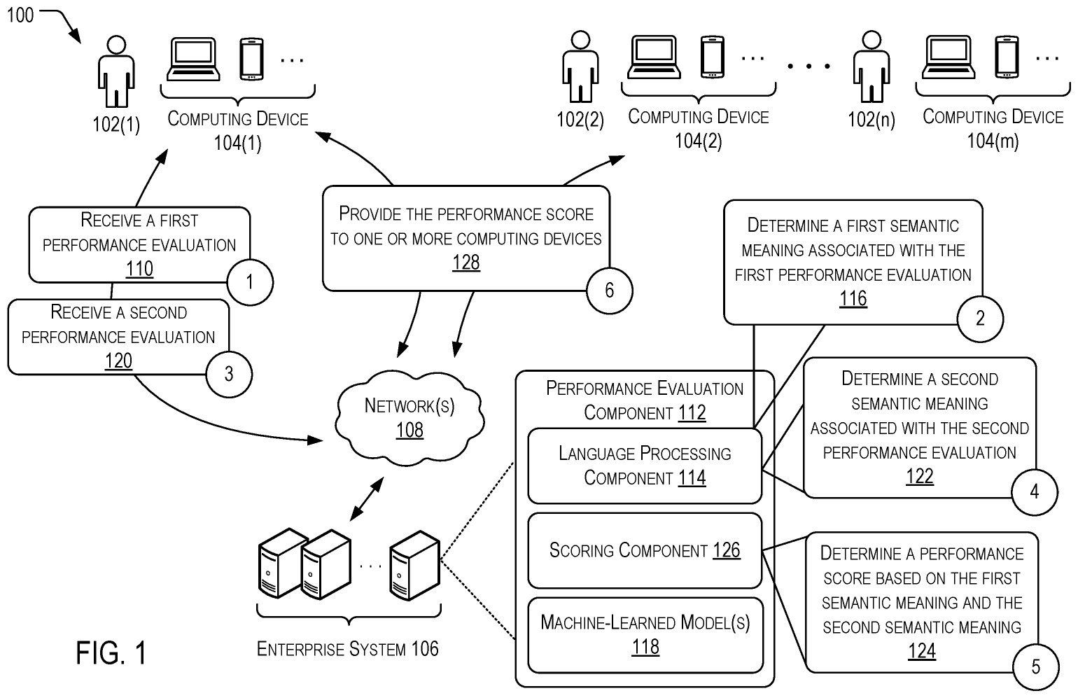

FIG. 1 is a schematic view of an example computing system 100 usable to implement example techniques described herein to facilitate performance summarization over time on an application via the system 100. In some examples, the system 100 may include users 102(1), 102(2), . . . 102(n) (collectively “users 102”) to interact using computing devices 104(1), 104(2), . . . 104(m) (collectively “computing devices 104”) with an enterprise system 106 via a network 108. In this example, n and m are non-zero integers greater than 1.

Each of the computing devices 104 includes one or more processors and memory storing computer executable instructions to implement the functionality discussed herein attributable to the various computing devices. In some examples, the computing devices 104 may include desktop computers, laptop computers, tablet computers, mobile devices (e.g., smart phones or other cellular or mobile phones, mobile gaming devices, portable media devices, etc.), or other suitable computing devices. The computing devices 104 may execute one or more client applications, such as a web browser (e.g., Microsoft Windows Internet Explorer, Mozilla Firefox, Apple Safari, Google Chrome, Opera, etc.) and/or a native or special-purpose client application (e.g., social media applications, messaging applications, email applications, games, etc.), to access and view content over the network 108.

The network 108 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which the computing devices 104 may access the enterprise system 106 and/or communicate with one another.

The enterprise system 106 may include one or more servers or other computing devices, any or all of which may include one or more processors and memory storing computer executable instructions to implement the functionality discussed herein attributable to the enterprise system or digital platform. The enterprise system 106 may enable its users 102 (such as persons or organizations) to interact with the enterprise system 106 and, in some cases, with each other via the computing devices 104. The enterprise system 106 may, with input from a user, create and store in the enterprise system 106 a user account associated with the user.

The user account may include demographic information, communication-channel information, employment information, and information related to performance of the user with relation to the enterprise. For instance, performance information stored by the enterprise system 106 may include quantitative metrics related to number of projects completed, timeliness on projects, efficiency on projects, sales revenue, number of sales completed, and the like. Additionally, in some cases, the performance information stored by the enterprise system 106 may include qualitative analysis provided by users of the enterprise system regarding a different user of the enterprise system 106. In some examples, the qualitative analysis may include text inputs (e.g., a text string) provided by users of the enterprise system 106. For instance, the enterprise system 106 may solicit open-ended feedback from users of the enterprise system 106 regarding a particular employee in association with a performance evaluation. Alternatively or additionally, the enterprise system 106 may receive and store feedback outside of a scheduled performance evaluation, such as via a feedback form provided on a website that is accessible to customers or employees to submit feedback as desired, via emails received by the enterprise system 106 regarding a particular employee, and so forth.

The enterprise system 106 may be configured to facilitate performance summarization over time for the users 102 via the computing devices 104.

For example, at operation 110 (indicated by “1”), a language processing component 114 of the enterprise system 106 may receive a first performance evaluation from a user account associated with the user 102(1). As used herein, a performance evaluation may refer to feedback and/or performance metrics associated with a particular employee (or other types of personnel, such as an independent contractor, a volunteer, etc.). In some examples, the user 102(1) that provides the feedback may be a person other than the employee included in the performance evaluation, such as one or more supervisors of the employee, one or more subordinates of the employee, one or more colleagues of the employee, one or more customers that interacted with the employee, one or more contractors that interacted with the employee, and so forth. Feedback received as part of the performance evaluation may be quantitative feedback (e.g., a rating on a scale of 1-5, a binary indication, and so on) and/or qualitative feedback (e.g., responses to open-ended questions, as described herein). In some cases, the feedback may include an indication of recognition for the employee, such as a cheer, a thumbs-up, a thumbs-down, and so forth.

The language processing component 114 may receive the first performance evaluation at a first time. For instance, an enterprise utilizing the enterprise system 106 may conduct performance evaluations of employees on a regular schedule, such as once a month, once a quarter, biannually (e.g., one review each half-year), once a year, and so forth. In such examples, the language processing component 114 may receive the first performance evaluation according to the schedule of the enterprise. Alternatively or additionally, the user 102(1) may provide the first performance evaluation independent of a schedule, such as in response to an event (e.g., the employee receiving the performance evaluation completing a difficult project, the employee receiving the performance evaluation failing to meet a deadline, etc.).

At operation 116 (indicated by “2”), the language processing component 114 determines a first semantic meaning associated with the first performance evaluation. In some examples, the language processing component 114 determines that the first performance evaluation includes a text string, which may correspond to an open-ended response to a request for feedback (e.g., a question or prompt) of the performance evaluation. In some cases, the text string may be a text string provided in a text entry field of the performance evaluation.

Alternatively or additionally, the language processing component 114 and/or the computing device 104(1) may generate the text string based at least in part on an audio input captured by a microphone of the computing device 104(1), such as were the user 102(1) verbally provides a response to a prompt in the performance evaluation. For instance, the language processing component 114 may generate a transcription of a conversation between the employee and another user (e.g., a verbal performance review, a customer interaction, etc.), may generate a transcription of verbal feedback provided by another user regarding the employee, and the like. Other examples of inputs that may be used to generate the text string are also considered.

In examples, the language processing component 114 determines the semantic meaning from the text string included in the performance evaluation. To do so, the language processing component 114 may leverage one or more machine-learned models 118 of the performance evaluation component 112. For instance, the language processing component 114 may input the text string into a deep neural network of the machine learned models 118, where the deep neural network is trained to determine a sentiment of the text string and/or multiple text strings included in the performance evaluation. The deep neural network may perform sentiment analysis to determine a polarity of the text string (e.g., positive, negative, or neutral sentiment based on the words included in the text string), an emotional state associated with the text string (e.g., happy, sad, angry, proud, frustrated, etc.), and the like.

In some cases, the language processing component 114 may assign a score to the sentiment received from the machine-learned model 118. In an illustrative example of a polarity analysis, the language processing component 114 may assign a score of 1 to a text string having a negative sentiment, a score of 2 to a text string having a neutral sentiment, and a score of 3 to a text string having a positive sentiment. In an illustrative example of an emotional analysis, different emotions may each receive a score (e.g., ranging from 1-5) based on how strongly each emotion is expressed in the text string (where a score of 1 corresponds to not expressed at all, and a score of 5 corresponds to deeply expressed). Any scoring system may be used to assign scores to different sentiments without departing from the scope herein.

At operation 120 (indicated by “3”), the language processing component 114 receives a second performance evaluation. The second performance evaluation may be provided by the same user 102(1) that provided the first performance evaluation, or may be a different user of the enterprise system 106. The second performance evaluation may also include quantitative feedback and/or qualitative feedback, similar to the first performance evaluation. The second performance evaluation may include responses to the same prompts included in the first performance evaluation, or may include different prompts to which the user 102(1) (or a different user) provides feedback.

The language processing component 114 may receive the second performance evaluation at a second time, such as after the first time at which the first performance evaluation was received. As mentioned above, an enterprise utilizing the enterprise system 106 may conduct performance evaluations of employees on a regular schedule, such as once a month, once a quarter, biannually (e.g., one review each half-year), once a year, and so forth. In such examples, the language processing component 114 may receive the first performance evaluation and the second performance evaluation according to the schedule of the enterprise. In an illustrative example, the language processing component 114 may receive the first performance evaluation at the conclusion of the first quarter of the enterprise, and then receive the second performance evaluation at the conclusion of the second quarter of the enterprise. Alternatively or additionally, the user 102(1) may provide the second performance evaluation independent of a schedule but at a different time than the first performance evaluation, such as in response to an event (e.g., the employee receiving the performance evaluation completing a difficult project, the employee receiving the performance evaluation failing to meet a deadline, etc.).

At operation 122 (indicated by “4”), the language processing component 114 determines a second semantic meaning associated with the second performance evaluation. Similar to the first performance evaluation, the language processing component 114 may determine that the second performance evaluation includes a text string, which may correspond to an open-ended response to a request for feedback (e.g., a question or prompt) of the performance evaluation. The text string may be a text string provided in a text entry field of the performance evaluation, and/or a different input type as described above. In some cases, the request for feedback included in the second performance evaluation may be a same (or similar) request that was included in the first performance evaluation. In cases where the request solicits open-ended feedback, however, the responses to the request may be different from one performance evaluation to another.

Similar to the first performance evaluation, the language processing component 114 determines the semantic meaning from the text string included in the second performance evaluation, such as by using the machine-learned models 118. For instance, a deep neural network of the machine-learned models 118 may perform sentiment analysis to determine a polarity of the text string (e.g., positive, negative, or neutral sentiment based on the words included in the text string), an emotional state associated with the text string (e.g., happy, sad, angry, proud, frustrated, etc.), and the like. In some cases, the language processing component 114 may assign a score to the sentiment received from the machine-learned model 118, as described above.

At operation 124 (indicated by “5”), a scoring component 126 determines a performance score based on the first semantic meaning and the second semantic meaning In some examples, the performance score may correspond to how the semantic meanings in multiple performance reviews has changed over time, and/or a trend associated with sentiment(s) expressed in performance reviews over time. In this way, the scoring component 126 summarizes sentiments expressed in multiple performance reviews to give the user 102(1) a picture of whether performance of an employee is improving, whether a reputation of the employee is improving, whether the employee is taking on appropriate projects or goals, whether the employee is making good decisions, how the employee is handling obstacles, and so on.

To determine a performance score for an employee, the scoring component 126 may, in some cases, use a formula such as the following:

P=S₂−S₁

Where P corresponds to the performance score determined based on a difference between a score associated with a semantic meaning determined from the second performance evaluation S₂ and a score associated with a semantic meaning determined from the first performance evaluation S₁. Accordingly, P may have a negative value, which may indicate a negative trend associated with open-ended feedback received regarding the employee. In some cases, P may have a positive value, which may indicate a positive trend associated with open-ended feedback received regarding the employee.

Alternatively or additionally, the scoring component 126 may leverage the machine-learned models 118 to determine the performance score based on the first semantic meaning included in the first performance evaluation and the second semantic meaning included in the second performance evaluation. For example, the scoring component 126 may use a linear regression model (e.g., simple linear regression, multiple linear regression, ordinary least squares, gradient descent, etc.) to determine a performance score over time based on semantic meanings included in performance evaluations received at different times. The scoring component 126 may input the first semantic meaning (or one or more scores associated therewith) and the second semantic meaning (or one or more scores associated therewith) into the machine-learned model 118. Then, the scoring component 126 may receive the performance score from the machine-learned model 118, where the performance score summarizes the semantic meanings of feedback received about an employee over time.

By using the machine-learned model 118, the scoring component 126 may analyze the two performance evaluations (or more performance evaluations, e.g., 5, 10, 100, etc.) while reducing processing resources of the enterprise system 106 and data transferred over the network 108. In particular, the described techniques provide the performance score to the user 102(1) such that the user 102(1) does not have to access and view each performance evaluation individually to determine how sentiment for the employee has changed over time.

In addition to open-ended feedback included in the performance evaluations, the scoring component 126 may use other metrics to determine and/or modify the performance score for an employee as well. For instance, the enterprise system 106 may receive one or more goals for the employee, and metrics associated with the goal(s) over time. The enterprise system 106 may receive the goal as part of the first performance evaluation, and may receive a status that corresponds to completion of the goal as part of the second performance evaluation.

In an illustrative example, the employee (and/or another person with access to the enterprise system 106) may set a sales goal for the employee of $100,000 for a quarter, and the enterprise system 106 may monitor the amount in sales for the employee as the quarter progresses. If the employee completes $120,000 in sales during the quarter, the scoring component 126 may modify a performance score for the employee to reflect the employee performing above expectations with regard to the sales goal. In another illustrative example, the employee may set a goal to develop five widgets during a quarter, and the enterprise system 106 may track how many widgets (or portions of widgets) that are completed as the quarter progresses. If the employee only finishes developing three widgets during the quarter, the scoring component 126 may modify a performance score for the employee to reflect the employee performing below expectations with regard to the goal of developing a certain number of widgets.

The scoring component 126 may weight different inputs into the performance score differently. For example, the scoring component 126 may receive a first weight (e.g., 0.2, 0.5, 0.8, etc.) to assign to the feedback received in the performance evaluations from the user 102(1), and a second weight (e.g., 0.8, 0.5, 0.2) to assign to completion of a goal by the employee. In this way, the performance evaluation system 112 allows users of the enterprise system 106 to place more or less weight on feedback provided in performance evaluations relative to other performance metrics, such as completion of goals or tasks.

At operation 128 (indicated by “6”), the performance evaluation component 112 provides the performance score to one or more of the computing devices 104. For example, the performance evaluation component 112 may provide the performance score as part of a user interface to the computing device 104(1), which may be associated with a supervisor (e.g., the user 102(1)) of the employee in the performance evaluations. Alternatively or additionally, the performance evaluation component 112 may provide the performance score as part of a user interface to one or more of the computing devices 104(2)-104(m), which may be associated with the employee evaluated in the performance evaluations, a customer of the employee, a co-worker of the employee, and so forth. In some cases, a user interface provided to a supervisor of the employee evaluated in the performance evaluations may be different from user interface(s) provided to the employee and/or other individuals having access to the enterprise system 106. For instance, a supervisor of the employee may be able to view how the employee ranks with other employees based on each employee's performance scores while the employee can only view their own performance score itself (without the rank), or vice versa.

Although not explicitly pictured, the user 102(1) may request an up to date performance score for an employee. For example, the user 102(1) may provide the first performance evaluation and the second performance evaluation for an employee according to a schedule, such as at the culmination of a first quarter and a second quarter of the enterprise, respectively. The user 102(1) may then access the enterprise system 106 at a third time after the first performance evaluation and the second performance evaluation have been submitted, such as partially through a third quarter, and request an up to date performance score.

The performance evaluation component 112 may determine a second performance score for the employee. For instance, the performance evaluation component 112 may determine a second performance score corresponding to a time since the first performance score was determined (e.g., a performance score associated with the time elapsed in the third quarter, according to the example above). Because the performance evaluation component 112 may not have access to up to date performance evaluations (and responses to open-ended feedback requests often included therein) to determine the second performance score, the second performance score may be based on other quantitative metrics for the time period since the first performance score was calculated, such as goal completion, a number of projects completed, timeliness on projects, efficiency on projects, sales revenue, number of sales completed, and the like. Of course, examples are considered in which the performance evaluation component 112 incorporates qualitative metrics as well, according to the described techniques.

In some examples, the performance evaluation component 112 combines the first performance score with the second performance score to determine an up to date performance score. The performance evaluation component 112 may combine the first performance score with the second performance score using a weighted average. For example, the first performance score may be weighted more heavily (e.g., 1.5×, 2×, 5×, etc) than the second performance score due to the first performance score evaluating more time and more data types (e.g., qualitative responses) associated with the employee. In another example, the second performance score may be weighted more heavily (e.g., 1.5×, 2×, 5×, etc.) than the first performance score due to events associated with the second performance score taking place more recently than events associated with the first performance score. The performance evaluation component 112 may provide the up to date performance score to the computing device 104(1) to display in a user interface, which may be displayed with the first performance score and/or the second performance score for comparison by the user 102(1).

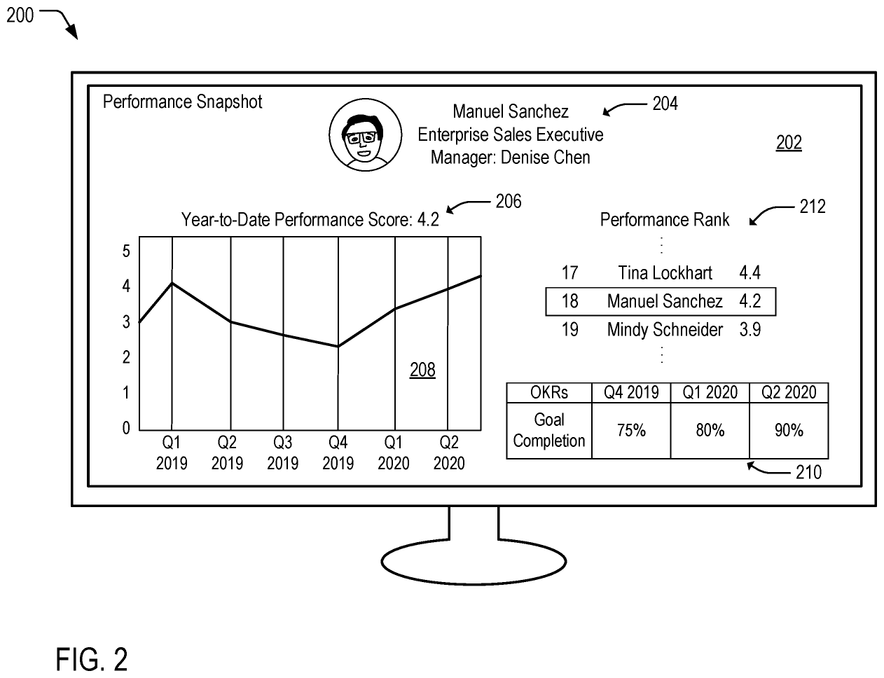

FIG. 2 depicts an example computing device 200 (which may correspond to any of the computing devices 104) displaying a user interface 202 that is usable to provide a performance summarization over time using the techniques described herein. The user interface 202 includes information 204 about an employee, Manuel Sanchez, who is an employee of an enterprise utilizing the enterprise system 106 of FIG. 1. In some examples, the information 204 may include an employee name, an employee title, a manager of the employee, an image of the employee, and the like.

Additionally, in some cases, the user interface 202 may include a performance score 206 for the employee. As described herein, the performance score 206 may provide a performance summary over time, where the performance score is based on qualitative and/or quantitative metrics associated with the employee. In the illustrated example, the performance score 206 has been calculated for a fiscal year, and is based on performance evaluations received throughout the fiscal year at each quarter (e.g., four performance evaluations). The performance score 206 in this example also takes into account performance metrics that are received after the final scheduled performance evaluation has taken place, such as metrics related to completion of a goal submitted in the most recent performance evaluation.

The user interface 202 may also include a chart 208 that illustrates how performance scores for the employee have changed over time. For example, the chart 208 may be based on a rolling average of performance scores determined using performance evaluations for a number of previous quarters (e.g., two quarters, three quarters, four quarters, etc.). While the chart 208 in the illustrated example indicates performance scores on a scale of 0 to 5, any suitable scale or indication of performance scores may be used, such as a scale of 0-100%, a letter grade scale (A, B, C, D, F, etc.), a color scale (e.g., red, yellow, green, etc.), and so forth.

In some cases, the performance score 206 illustrated in the user interface 202 may be based, at least in part, on goal completion by the employee as described herein. Accordingly, the user interface 202 may include a representation 210 of goal completion by the employee over time. A user viewing the user interface 202 is provided with a summary of a significant amount of data regarding the employee's performance. For instance, if the representation 210 of goal completion by the employee compliments the performance score 206 (e.g., both are trending positively or both are trending negatively), a user viewing the interface may be able to more quickly ascertain that the employee should be eligible for a promotion (e.g., both trending positively) or may need to conduct a discussion with the employee about changing behavior (e.g., both trending negatively). If the representation 210 of goal completion by the employee deviates from the performance score 206 (e.g., one is trending positively one is trending negatively), a user viewing the interface may view more details associated with one or both of the performance score 206 (e.g., individual performance reviews) and the representation 210 of goal completion, and conduct a review with the employee on how to improve in a specific area that is trending negatively.

In addition, the user interface 202 may include a representation 212 of a rank of the employee relative to other employees in the enterprise based on the performance score 206. In some cases, the representation 212 may be limited to employees of the enterprise having similar roles, such as ranking members of a sales department separately from members of an engineering department of the enterprise. However, examples are considered in which the representation 212 ranking employees is independent of a role or department of the individual employees (e.g., all employees are included and ranked). The representation 212 may include names or other types indicators of other employees against which the employee is ranked. Additionally, in some examples, the representation 212 may include the performance score 206 along with performance scores of the other employees against which the employee is ranked, so that a user viewing the user interface 202 gets a sense of a spread in performance scores amongst employees. Examples are also considered in which the representation 212 displays the rank (e.g., the number 17 in this case) of the employee absent names or other types of indicators of other employees, and/or absent performance scores for other employees, to provide privacy amongst various employees of the enterprise.

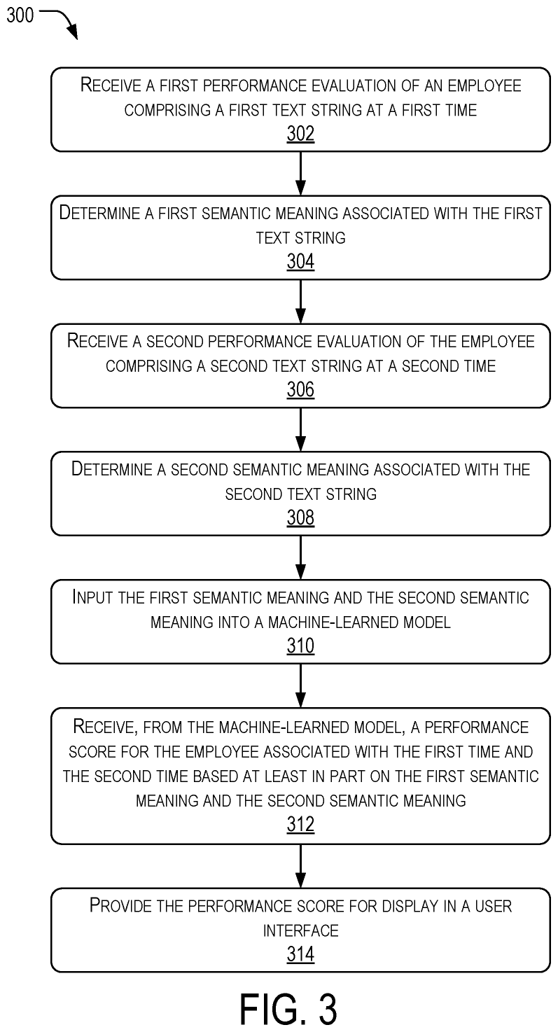

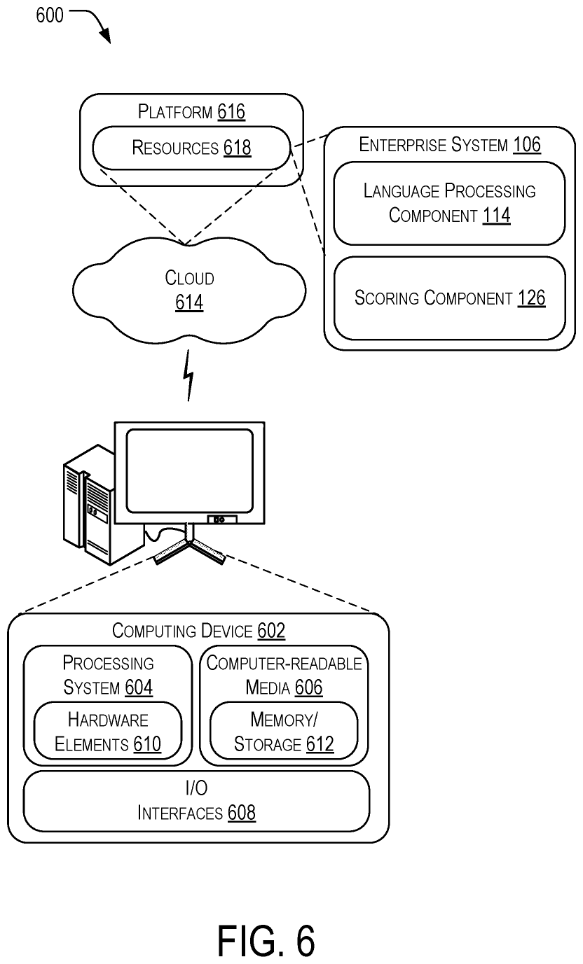

FIGS. 3-5 illustrate example processes for performance summarization over time by an enterprise system using the techniques described herein. Various methods are described with reference to the example system of FIG. 1 and/or the user interface of FIG. 2 for convenience and ease of understanding. However, the methods described are not limited to being performed using the systems of FIG. 1 or FIG. 6 and/or the user interface of FIG. 2, and may be implemented using systems and devices other than those described herein.

The methods described herein represent sequences of operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes. In some examples, one or more operations of the methods may be omitted entirely. Moreover, the methods described herein can be combined in whole or in part with one another, and/or with other methods.

FIG. 3 illustrates a flowchart outlining an example method 300 to utilize a machine-learned model to determine a performance score based on semantic meanings derived from performance evaluations received at different times using the techniques described herein.

At operation 302, the performance evaluation component 112 receives a first performance evaluation of an employee comprising a first text string at a first time. Feedback received as part of the performance evaluation may be quantitative feedback (e.g., a rating on a scale of 1-5, a binary indication, and so on) and/or qualitative feedback (e.g., responses to open-ended questions, as described herein). In some cases, the feedback may include an indication of recognition for the employee, such as a cheer, a thumbs-up, a thumbs-down, and so forth. In examples, first performance evaluation may be received at the first time according to a performance evaluation schedule, such as once a month, once a quarter, biannually (e.g., one review each half-year), once a year, and so forth. Examples are also considered in which the first time at which the first performance evaluation is received is in response to an event (e.g., the employee receiving the performance evaluation completing a difficult project, the employee receiving the performance evaluation failing to meet a deadline, etc.).

At operation 304, the performance evaluation component 112 determines a first semantic meaning associated with the first text string. In some cases, the text string may be a text string provided in a text entry field of the performance evaluation. Alternatively or additionally, the language processing component 114 and/or the computing device 104(1) may generate the text string based at least in part on an audio input captured by a microphone of the computing device 104(1). In examples, the language processing component 114 may input the text string into a deep neural network of the machine learned models 118, where the deep neural network is trained to determine a sentiment of the text string and/or multiple text strings included in the performance evaluation.

At operation 306, the performance evaluation component 112 receives a second performance evaluation of the employee comprising a second text string at a second time. The second performance evaluation may also include quantitative feedback and/or qualitative feedback, similar to the first performance evaluation. The second performance evaluation may include responses to the same prompts included in the first performance evaluation, or may include different prompts to which the user 102(1) (or a different user) provides feedback. The language processing component 114 may receive the first performance evaluation and the second performance evaluation according to the schedule of the enterprise, where the second performance evaluation is received after the first performance evaluation based on the schedule. Alternatively or additionally, the user 102(1) may provide the second performance evaluation independent of a schedule but at a different time than the first performance evaluation, such as in response to an event (e.g., the employee receiving the performance evaluation completing a difficult project, the employee receiving the performance evaluation failing to meet a deadline, etc.).

At operation 308, the performance evaluation component 112 determines a second semantic meaning associated with the second text string. In some cases, the request for feedback included in the second performance evaluation may be a same (or similar) request that was included in the first performance evaluation. In cases where the request solicits open-ended feedback, however, the responses to the request may be different from one performance evaluation to another. Similar to the first performance evaluation, the language processing component 114 determines the semantic meaning from the text string included in the second performance evaluation, such as by using the machine-learned models 118, such as by using a deep neural network.

At operation 310, the performance evaluation component 112 inputs the first semantic meaning and the second semantic meaning into a machine-learned model. For example, the scoring component 126 may use a linear regression model as mentioned above to determine a performance score over time based on semantic meanings included in performance evaluations received at different times.

At operation 312, the performance evaluation component 112 receives, from the machine-learned model, a performance score for the employee associated with the first time and the second time, and based at least in part on the first semantic meaning and the second semantic meaning In examples, the performance score summarizes the semantic meanings of feedback received about an employee over time. By using the machine-learned model 118, the scoring component 126 may analyze the two performance evaluations (or more performance evaluations, e.g., 5, 10, 100, etc.) while reducing processing resources of the enterprise system 106 and data transferred over the network 108. In particular, the described techniques provide the performance score to the user 102(1) such that the user 102(1) does not have to access and view each performance evaluation individually to determine how sentiment for the employee has changed over time.

At operation 314, the performance evaluation component 112 provides the performance score for display in a user interface. For example, the performance evaluation component 112 may provide the performance score as part of a user interface to the computing device 104(1), which may be associated with a supervisor (e.g., the user 102(1)) of the employee in the performance evaluations. Alternatively or additionally, the performance evaluation component 112 may provide the performance score as part of a user interface to one or more of the computing devices 104(2)-104(m), which may be associated with the employee evaluated in the performance evaluations, a customer of the employee, a co-worker of the employee, and so forth.

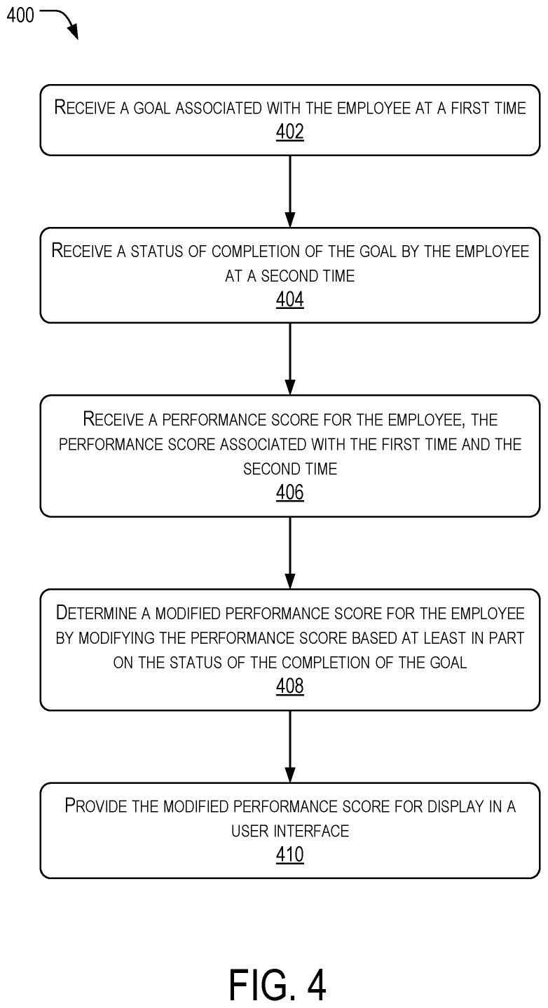

FIG. 4 illustrates a flowchart outlining an example method 400 to modify a performance score for an employee based on status of completion of a goal associated with the employee using the techniques described herein.

At operation 402, the performance evaluation component 112 receives a goal associated with an employee at a first time. For example, the goal may be provided as part of a performance evaluation, where the first time is associated with a performance evaluation schedule for an enterprise utilizing the enterprise system 106. Alternatively or additionally, the goal may be provided independent of a performance evaluation, and/or independent of a schedule of the enterprise system for recording goals. The goal may include one or more objectives and/or key results. The objective may correspond to a definition for the goal. In an illustrative example, the employee may have a goal to create a better customer experience. The key results may correspond to specific and measurable actions that, if executed by the employee, will result in achievement of the objective. Continuing with the illustrative example, the key results to achieve a better customer experience might be to increase a net promoter score by 10%, increase a repurchase rate by 12%, and reduce a customer acquisition cost by 3%.

At operation 404, the performance evaluation component 112 receives a status of completion of the goal by the employee at a second time. The status of completion of the goal may be received as part of a scheduled performance evaluation, and/or outside of a performance evaluation schedule. For instance, referencing the illustrative example once again, the performance evaluation component 112 may receive a performance evaluation at the end of a quarter that indicates that the goal was achieved by the employee. The performance evaluation may indicate that the goal was achieved by the status of the key results corresponding to an increase a net promoter score by 11%, an increase a repurchase rate by 15%, and a reduction of a customer acquisition cost by 5%.

At operation 406, the performance evaluation component 112 receives a performance score for an employee, where the performance score is associated with the first time and the second time. As described herein, the performance evaluation component 112 may receive a first performance evaluation for the employee at the first time (e.g., that includes the goal), and a second performance evaluation for the employee at the second time (e.g., that includes the status of completion of the goal). The performance evaluation component 112 may determine semantic meanings for text strings included in the first and second performance evaluations. In some examples, the performance evaluation component 112 inputs the semantic meanings into a machine-learned model trained to determine performance over time based at least in part on semantics of employee feedback. The performance evaluation component 112 may then receive the performance score for the employee from the machine-learned model that reflects how the semantic meanings have changed over time.

At operation 408, the performance evaluation component 112 determines a modified performance score for the employee by modifying the performance score based at least in part on the status of the completion of the goal. For example, if the employee exceeds the expectations set forth in the key results, the scoring component 126 may increase the performance score, such as by adding to the performance score based on an amount that the expectations were exceeded. On the other hand, if the employee falls below the expectations set forth in the key results, the scoring component 126 may decrease the performance score, such as by subtracting from the performance score based on an amount that the employee fell short of the expectations. The scoring component 126 may weight feedback received in performance evaluations differently than goal achievement in determining the modified performance score. For example, the scoring component 126 may receive a first weight (e.g., 0.2, 0.5, 0.8, etc.) to assign to the feedback received in the performance evaluations from the user 102(1), and a second weight (e.g., 0.8, 0.5, 0.2) to assign to completion of a goal by the employee. In this way, the performance evaluation system 112 allows users of the enterprise system 106 to place more or less weight on feedback provided in performance evaluations relative to other performance metrics, such as completion of goals or tasks.

At operation 410, the performance evaluation component 112 provides the modified performance score for display in a user interface. Similar to the discussion above, the performance evaluation component 112 may provide the performance score as part of a user interface to the computing device 104(1), which may be associated with a supervisor (e.g., the user 102(1)) of the employee in the performance evaluations. Alternatively or additionally, the performance evaluation component 112 may provide the performance score as part of a user interface to one or more of the computing devices 104(2)-104(m), which may be associated with the employee evaluated in the performance evaluations, a customer of the employee, a co-worker of the employee, and so forth. The modified performance score may be displayed in the user interface with the performance score associated with feedback received in performance evaluations, and/or in place of the performance score associated with feedback received in performance evaluations.

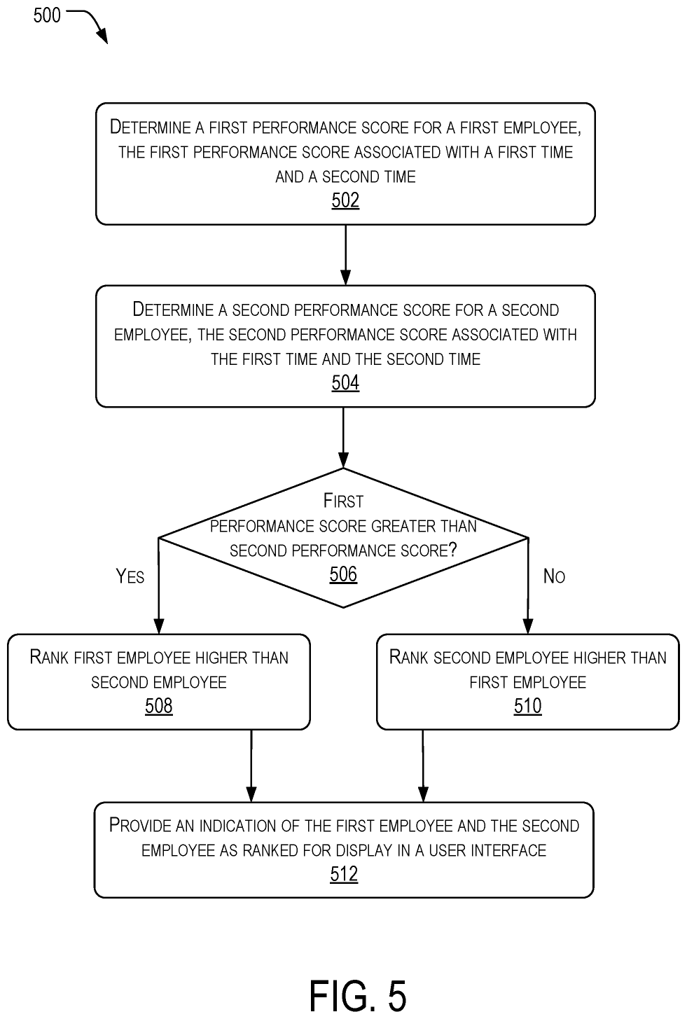

FIG. 5 illustrates a flowchart outlining an example method 500 to rank employees based on performance scores using the techniques described herein.

At operation 502, the performance evaluation component 112 determines a first performance score for a first employee, where the first performance score is associated with a first time and a second time. As described herein, the performance evaluation component 112 may receive a first performance evaluation for the first employee at a first time, and a second performance evaluation for the first employee at a second time. The performance evaluation component 112 may determine semantic meanings for text strings included in the first and second performance evaluations associated with the first employee. In some examples, the performance evaluation component 112 inputs the semantic meanings into a machine-learned model trained to determine performance over time based at least in part on semantics of employee feedback. The performance evaluation component 112 may then receive the performance score for the first employee from the machine-learned model that reflects how the semantic meanings have changed over time.

At operation 504, the performance evaluation component 112 determines a second performance score for a second employee, where the second performance score is also associated with the first time and the second time. Similar to the discussion above, the performance evaluation component 112 may receive a first performance evaluation for the second employee at the first time, and a second performance evaluation for the second employee at the second time. The performance evaluation component 112 may determine semantic meanings for text strings included in the first and second performance evaluations associated with the second employee. In some examples, the performance evaluation component 112 inputs the semantic meanings into the machine-learned model trained to determine performance over time based at least in part on semantics of employee feedback. The performance evaluation component 112 may then receive the performance score for the second employee from the machine-learned model that reflects how the semantic meanings have changed over time.

At operation 506, the performance evaluation component 112 determines whether the first performance score is greater than the second performance score. For example, the performance evaluation component 112 compares a value of the first performance score to a value of the second performance score to determine which performance score is greater. If the first performance score is greater than the second performance score (e.g., “Yes” at operation 506), the performance evaluation component 112 proceeds to operation 508, and ranks the first employee higher than the second employee. If the first performance score is less than the second performance score (e.g., “No” at operation 506), the performance evaluation component 112 proceeds to operation 510, and ranks the second employee higher than the first employee. In some examples (although not explicitly pictured), if the first performance score is equal to the second performance score, the performance evaluation component may provide the same rank to the first employee and the second employee.

At operation 512, the performance evaluation component 112 provides an indication of the first employee and the second employee as ranked for display in a user interface. Similar to the discussion above, the performance evaluation component 112 may provide the indication of the first employee and the second employee as ranked as part of a user interface to the computing device 104(1), which may be associated with a supervisor (e.g., the user 102(1)) of the at least one of the ranked employees. Alternatively or additionally, the performance evaluation component 112 may provide the indication of the first employee and the second employee as ranked as part of a user interface to one or more of the computing devices 104(2)-104(m), which may be associated with an employee that was ranked, a customer of a ranked employee, a co-worker of a ranked employee, and so forth. The indication of the first employee and the second employee as ranked may be displayed in the user interface with the performance scores associated with feedback received in performance evaluations of the ranked employees as well.

### Example System and Device

FIG. 6 illustrates an example system generally at 600 that includes an example computing device 602 that is representative of one or more computing systems and/or devices that may implement the various techniques described herein. This is illustrated through inclusion of the enterprise system 106, the language processing component 114, and the scoring component 126. The computing device 602 may be, for example, a server of a service provider, a device associated with a client (e.g., a client device), an on-chip system, and/or any other suitable computing device or computing system.

The example computing device 602 as illustrated includes a processing system 604, one or more computer-readable media 606, and one or more I/O interface 608 that are communicatively coupled, one to another. Although not shown, the computing device 602 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 604 is representative of functionality to perform one or more operations using hardware. Accordingly, the processing system 604 is illustrated as including hardware element 610 that may be configured as processors, functional blocks, and so forth. This may include implementation in hardware as an application specific integrated circuit or other logic device formed using one or more semiconductors. The hardware elements 610 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 606 is illustrated as including a memory/storage component 612. The memory/storage component 612 represents memory/storage capacity associated with one or more computer-readable media. The memory/storage component 612 may include volatile media (such as random access memory (RAM)) and/or nonvolatile media (such as read only memory (ROM), Flash memory, optical disks, magnetic disks, and so forth). The memory/storage component 612 may include fixed media (e.g., RAM, ROM, a fixed hard drive, and so on) as well as removable media (e.g., Flash memory, a removable hard drive, an optical disc, and so forth). The computer-readable media 606 may be configured in a variety of other ways as further described below.

Input/output interface(s) 608 are representative of functionality to allow a user to enter commands and information to computing device 602, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 602 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” “logic,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on and/or transmitted across some form of computer-readable media. The computer-readable media may include a variety of media that may be accessed by the computing device 602. By way of example, and not limitation, computer-readable media may include “computer-readable storage media” and “computer-readable transmission media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer-readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable transmission media” may refer to a medium that is configured to transmit instructions to the hardware of the computing device 602, such as via a network. Computer-readable transmission media typically may transmit computer-readable instructions, data structures, program modules, or other data in a modulated data signal, such as carrier waves, data signals, or other transport mechanism. Computer-readable transmission media also include any information delivery media. The term “modulated data signal” means a signal that has one or more of its characteristics set or changed in such a manner as to encode information in the signal. By way of example, and not limitation, computer-readable transmission media include wired media such as a wired network or direct-wired connection, and wireless media such as acoustic, radio frequency (RF), infrared, and other wireless media.

As previously described, hardware elements 610 and computer-readable media 606 are representative of modules, programmable device logic and/or device logic implemented in a hardware form that may be employed in some examples to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 610. The computing device 602 may be configured to implement particular instructions and/or functions corresponding to the software and/or hardware modules. Accordingly, implementation of a module that is executable by the computing device 602 as software may be achieved at least partially in hardware, e.g., through use of computer-readable storage media and/or hardware elements 610 of the processing system 604. The instructions and/or functions may be executable/operable by one or more articles of manufacture (for example, one or more computing devices 602 and/or processing systems 604) to implement techniques, modules, and examples described herein.

The techniques described herein may be supported by various configurations of the computing device 602 and are not limited to the specific examples of the techniques described herein. This functionality may also be implemented all or in part through use of a distributed system, such as over a “cloud” 614 via a platform 616 as described below.

The cloud 614 includes and/or is representative of a platform 616 for resources 618. The platform 616 abstracts underlying functionality of hardware (e.g., servers) and software resources of the cloud 614. The resources 618 may include applications and/or data that can be utilized while computer processing is executed on servers that are remote from the computing device 602. Resources 618 can also include services provided over the Internet and/or through a subscriber network, such as a cellular or Wi-Fi network.

The platform 616 may abstract resources and functions to connect the computing device 602 with other computing devices. The platform 616 may also be scalable to provide a corresponding level of scale to encountered demand for the resources 618 that are implemented via the platform 616. Accordingly, in an interconnected device example, implementation of functionality described herein may be distributed throughout multiple devices of the system 600. For example, the functionality may be implemented in part on the computing device 602 as well as via the platform 616 which may represent a cloud computing environment, such as the cloud 614.

### CONCLUSION

Although the discussion above sets forth example implementations of the described techniques, other architectures may be used to implement the described functionality, and are intended to be within the scope of this disclosure. Furthermore, although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method comprising:
receiving a first performance evaluation of an employee comprising a first text string at a first time;
determining a first semantic meaning associated with the first text string;
receiving a second performance evaluation of the employee comprising a second text string at a second time;
determining a second semantic meaning associated with the second text string;
inputting the first semantic meaning and the second semantic meaning into a machine-learned model trained to determine performance over time based at least in part on semantics of employee feedback;
receiving, from the machine-learned model, a performance score for the employee associated with the first time and the second time based at least in part on the first semantic meaning and the second semantic meaning; and
displaying the performance score in a user interface.

2. The method of claim 1, wherein the first time and the second time are separated by an amount of time, the amount of time corresponding to at least one of:
a quarter year;
a half year; or
a year.

3. The method of claim 1, wherein the performance score is displayed in the user interface with additional performance scores associated with different times than the first time and the second time.

4. The method of claim 1, wherein:
the first performance evaluation includes a request for open-ended feedback and the first text string corresponds to a first response to the request for open-ended feedback,
the second performance evaluation includes the request for open-ended feedback and the second text string corresponds to a second response to the request for open-ended feedback, the second response being different than the first response.

5. The method of claim 1, further comprising:
determining a first sentiment of the first text string based at least in part on the first semantic meaning;
determining a second sentiment of the second text string based at least in part on the second semantic meaning; and
inputting the first sentiment and the second sentiment into the machine-learned model,
wherein the performance score for the employee is further based on the first sentiment and the second sentiment.

6. The method of claim 1, further comprising:
receiving a goal associated with the employee;
receiving a status of completion of the goal by the employee as part of the second performance evaluation at the second time; and
determining a modified performance score for the employee by modifying the performance score based at least in part on the status of the completion of the goal,
wherein displaying the performance score in the user interface comprises displaying the modified performance score.

7. The method of claim 6, further comprising:
receiving a weight to be associated with the completion of the goal relative to the performance score,
wherein determining the modified performance score is further based on the weight of the completion of the goal relative to the performance score.

8. The method of claim 1, wherein the employee is a first employee, and wherein the first performance evaluation and the second performance evaluation each comprise at least one of:
a first transcription of a conversation between the first employee and a second employee;
a second transcription of feedback supplied by the second employee to the first employee; or
an indication of recognition supplied by the second employee and associated with the first employee.

9. The method of claim 1, wherein the performance score is a first performance score, the method further comprising:
determining an up to date performance score by combining the first performance score with a second performance score for the employee; and
displaying the up to date performance score with the first performance score in the user interface.

10. The method of claim 1, wherein the employee is a first employee and the performance score is a first performance score, the method further comprising:
determining a second performance score for a second employee associated with the first time and the second time;
determining a rank of the first employee relative to the second employee based at least in part on comparing the first performance score and the second performance score; and
displaying the rank of the first employee with the first performance score in the user interface.

11. A system comprising:
one or more processors; and
one or more computer-readable media storing instructions that, when executed by the one or more processors, cause the one or more processors to perform operations comprising:
receiving a first performance evaluation of an employee comprising a first text string at a first time;
determining a first semantic meaning associated with the first text string;
receiving a second performance evaluation of the employee comprising a second text string at a second time;
determining a second semantic meaning associated with the second text string;
inputting the first semantic meaning and the second semantic meaning into a machine-learned model trained to determine performance over time based at least in part on semantics of employee feedback;
receiving, from the machine-learned model, a performance score for the employee associated with the first time and the second time based at least in part on the first semantic meaning and the second semantic meaning; and
displaying the performance score in a user interface.

12. The system of claim 11, wherein the performance score is displayed in the user interface with additional performance scores associated with different times than the first time and the second time.

13. The system of claim 11, wherein:
the first performance evaluation includes an open-ended question and the first text string corresponds to a first response to the open-ended question,
the second performance evaluation includes the open-ended question and the second text string corresponds to a second response to the open-ended question, the second response being different than the first response.

14. The system of claim 11, the operations further comprising:
determining a first sentiment of the first text string based at least in part on the first semantic meaning;
determining a second sentiment of the second text string based at least in part on the second semantic meaning; and
inputting the first sentiment and the second sentiment into the machine-learned model,
wherein the performance score for the employee is further based on the first sentiment and the second sentiment.

15. The system of claim 11, wherein the employee is a first employee, and wherein the first performance evaluation and the second performance evaluation each comprise at least one of:
a first transcription of a conversation between the first employee and a second employee;
a second transcription of feedback supplied by the second employee to the first employee; or
a third transcription of recognition supplied by the second employee and associated with the first employee.

16. One or more non-transitory computer-readable media storing instructions that, when executed by a processor, cause the processor to perform operations comprising:
receiving a first performance evaluation of an employee comprising a first text string at a first time;
determining a first semantic meaning associated with the first text string;
receiving a second performance evaluation of the employee comprising a second text string at a second time;
determining a second semantic meaning associated with the second text string;
inputting the first semantic meaning and the second semantic meaning into a machine-learned model trained to determine performance over time based at least in part on semantics of employee feedback;
receiving, from the machine-learned model, a performance score for the employee associated with the first time and the second time based at least in part on the first semantic meaning and the second semantic meaning; and
displaying the performance score in a user interface.

17. The one or more non-transitory computer-readable media of claim 16, the operations further comprising:
receiving a goal associated with the employee;
receiving a status of completion of the goal by the employee as part of the second performance evaluation at the second time; and
determining a modified performance score for the employee by modifying the performance score based at least in part on the status of the completion of the goal,
wherein displaying the performance score in the user interface comprises displaying the modified performance score.

18. The one or more non-transitory computer-readable media of claim 17, the operations further comprising:
receiving a weight to be associated with the goal relative to the performance score,
wherein determining the modified performance score is further based on the weight relative to the performance score.

19. The one or more non-transitory computer-readable media of claim 16, wherein the performance score is a first performance score, the operations further comprising:
determining an up to date performance score by combining the first performance score with a second performance score for the employee; and
displaying the up to date performance score with the first performance score in the user interface.

20. The one or more non-transitory computer-readable media of claim 16, wherein the employee is a first employee and the performance score is a first performance score, the operations further comprising:
determining a second performance score for a second employee associated with the first time and the second time;
determining a rank of the first employee relative to the second employee based at least in part on comparing the first performance score and the second performance score; and
displaying the rank of the first employee with the first performance score in the user interface.
